(19) United States
(12) Patent Application Publication
(10) Pub. No.: US 2023/0136837 A1
(43) Pub. Date: May 4, 2023

(54) METHOD FOR NAVIGATING THREAD-TYPE MESSAGES AND APPARATUS IMPLEMENTING THE SAME METHOD

(71) Applicant: Samsung SDS Co., Ltd., Seoul (KR)

(72) Inventors: Moon Young KWON, Seoul (KR); Ji Eun Yoon, Seoul (KR); Sun Hyo Lee, Seoul (KR); Yi Sun Chung, Seoul (KR); Hyun JI Rhee, Seoul (KR)

(73) Assignee: Samsung SDS Co., Ltd., Seoul (KR)

(21) Appl. No.: 17/966,339

(22) Filed: Oct. 14, 2022

(30) Foreign Application Priority Data
Oct. 29, 2021 (KR) 10-2021-0147265

(51) Int. Cl. H04L 51/216; G06F 3/04817; G06F 16/33

(52) U.S. Cl. CPC H04L 51/216; G06F 3/04817; G06F 16/3334

(57) ABSTRACT

Provided is a method for navigating thread-type messages performed by a user terminal. The method comprises extracting a plurality of core elements based on information collected from the thread-type messages in which a plurality of conversation messages are grouped, generating thumbnail configuration information on the thread-type messages using the plurality of core elements, and displaying a thumbnail view based on the thumbnail configuration information, the displaying being based on a user input for the thread-type message.

### CROSS-REFERENCE TO RELATED APPLICATION

This application claims priority from Korean Patent Application No. 10-2021-0147265 filed on Oct. 29, 2021, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for navigating thread-type messages and an apparatus implementing the same method, and more particularly, to a thread-type message navigation method to quickly navigate information of a thread-type message where a plurality of conversation messages are grouped, and an apparatus implementing the same method.

### 2. Description of the Related Art

Multiuser communication solutions enable collaboration for each topic by supporting a thread scheme that can derive sub-messages to an original message beyond the limits of linear message reception and transmission manners of conventional messaging services.

Since such a thread-type message consists of a bundle of several conversation messages, due to a large amount of information, it can be difficult to grasp core information, and it is difficult to quickly navigate threads associated with users.

Furthermore, the thread-type message has a problem that it is difficult to grasp at a glance what the core content is and what content has been exchanged within several conversation messages with different participants, and who participates and/or is involved in the messages.

In addition, among a list of thread-type messages, it is not easy to identify threads that the user directly created and participated in, or threads that are highly associated with the user.

Since the conventional thread-type message service only provides searches for individual conversation messages, in order to navigate desired core information within the entire conversation message, there was an inconvenience of having to go through trial and error by repeating several searches and moves.

Accordingly, when providing a thread-type message service, there is a need for a technology capable of quickly obtaining core information included in several conversation messages and navigating threads associated with the user or threads of a desired specific topic.

### SUMMARY

Aspects of the present disclosure provide a method for navigating thread-type messages and an apparatus implementing the same method that can extract and provide core information included within a bundle of several conversation messages within a service screen of a thread-type message.

Aspects of the present disclosure also provide a method for navigating thread-type messages and an apparatus implementing the same method that can provide information on core conversations, core participants, and core content included in several conversation messages via an intuitive interface in the form of a thumbnail, within a service screen of a thread-type message.

Aspects of the present disclosure also provide a method for navigating thread-type messages and an apparatus implementing the same method that can quickly navigate threads with high user association and threads with high similarity when providing a thread-type message service.

Aspects of the present disclosure also provide a method for navigating thread-type messages and an apparatus implementing the same method that can provide a thread-based search function without having to search for each conversation message to obtain the information desired by a user, when providing a thread-type message service.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to an embodiment of the present disclosure, there is provided a method for navigating thread-type messages performed by a user terminal. The method comprises extracting a plurality of core elements based on information collected from the thread-type messages in which a plurality of conversation messages are grouped, generating thumbnail configuration information on the thread-type messages using the plurality of core elements, and displaying a thumbnail view based on the thumbnail configuration information, the displaying being based on a user input for the thread-type message.

According to an embodiment of the present disclosure, there is provided a method for navigating thread-type messages, performed by a computing device. The method comprises receiving a navigation request for thread-type messages in which a plurality of conversation messages selected from a screen of a user terminal are grouped, extracting a plurality of core elements based on information collected from the thread-type messages, generating thumbnail configuration information on the thread-type messages using the plurality of core elements, and providing the thumbnail configuration information to the user terminal.

According to an embodiment of the present disclosure, there is provided a user terminal. The user terminal comprises a communication unit configured to communicate with an external device, a user input unit configured to receive a user input, a display unit configured to display information, and a processor configured to: display thread-type messages in which a plurality of conversation messages are grouped, on the display unit, extract a plurality of core elements based on information collected from the thread-type messages when there is a user input for the thread-type messages, generate thumbnail configuration information on the thread-type messages using the plurality of core elements, and control the display unit to display a thumbnail view based on the thumbnail configuration information.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating a configuration of a system for a thread-type message navigation according to one embodiment of the present disclosure;

FIG. 2 is a block diagram illustrating a configuration of a user terminal according to one embodiment of the present disclosure;

FIGS. 3 and 4 are flowcharts describing a method performed by the user terminal according to another embodiment of the present disclosure;

FIG. 5 illustrates an example of providing thumbnails for each thread in the form of a list according to some embodiments of the present disclosure;

FIG. 6 illustrates an example of providing thumbnails for each thread in the form of a card according to some embodiments of the present disclosure;

FIG. 7 illustrates an example of displaying an original thread or a similar thread when selecting a thumbnail according to some embodiments of the present disclosure;

FIGS. 8 and 9 illustrate examples of providing thumbnails for each thread in a mobile device according to some embodiments of the present disclosure;

FIG. 10 illustrates an example of displaying a thumbnail for some threads among all threads according to some embodiments of the present disclosure;

FIGS. 11 and 12 illustrate configuration examples of thumbnails according to some embodiments of the present disclosure;

FIG. 13 illustrates an example of providing a search function for a thumbnail according to some embodiments of the present disclosure;

FIG. 14 illustrates an example of displaying a thumbnail based on a degree of association with a user according to some embodiments of the present disclosure; and

FIG. 15 illustrates a hardware configuration diagram of an exemplary computing device capable of implementing methods according to some embodiments of the present disclosure.

### DETAILED DESCRIPTION OF THE EMBODIMENTS

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof

Hereinafter, some embodiments of the present disclosure will be described in detail with reference to the accompanying drawings

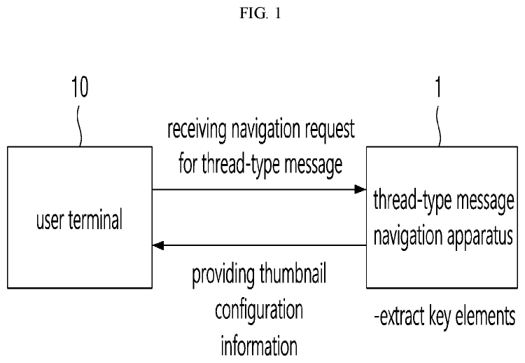

FIG. 1 is a block diagram illustrating a configuration of a system for a thread-type message navigation according to one embodiment of the present disclosure. Referring to FIG. 1, the system according to an embodiment of the present disclosure includes a user terminal 10 and a thread-type message navigation apparatus 1.

The thread-type message navigation apparatus 1 provides a service for multiuser communication such as a chat room service of a messenger, an email service and the like, and may be provided as a fixed computing device such as a server or a PC.

The user terminal 10 may be any one of, for example, a mobile computing device such as a smart phone, a tablet PC, a laptop PC, or a PDA, and a fixed computing device such as a personal desktop PC. The user terminal 10 may be implemented as a terminal that transmits a navigation request for thread-type messages to the thread-type message navigation apparatus 1 and provides a navigating result provided from the thread-type message navigation apparatus 1 in the form of a graphical user interface (GUI).

The thread-type message navigation apparatus 1 processes a navigation request for thread-type messages received from the user terminal 10 and provides the corresponding result. The thread-type message may include an upper conversation message and a plurality of lower conversation messages derived therefrom in a form in which a plurality of conversation messages are grouped.

The thread-type message navigation apparatus 1 extracts a plurality of core elements based on information collected from the thread-type messages with respect to the navigation request for the thread-type message received from the user terminal 10.

In that case, the navigation request received from the user terminal 10 may be received according to a user input for thread-type messages selected from a screen of the user terminal 10. The user input may include, for example, an operation of clicking or touching a button or tab displayed on a screen, an operation of swiping all or some areas of a conversation message, an operation of scrolling a mouse or clicking a shortcut for enlarging or reducing a scale, and a pinch-to-zoom or tap-to-zoom operation.

The thread-type message navigation apparatus 1 collects information on thread-type messages generated by communication between a plurality of user terminals and stores the information in a database. The information on the thread-type messages may be classified into, for example, basic information of a thread, participant information, upper message and lower message information, and content information.

The basic information of the thread may include, for example, the total number of messages included in the thread, the total number of participants, an activation period from the initial creation to the final update of the thread, the types of tags set in the thread (e.g., importance, announcement, storage, etc.), and information on keywords previously registered in the thread.

The participant information may include, for example, information on a creator, a participant, and a participating subject of the thread-type message. Herein, the creator may be defined as a person who has written the upper conversation message and the lower conversation message, and the participant may be defined as a person who has left a response to the conversation message. The reaction to the conversation message may include, for example, a recommendation for a conversation message, a reaction input such as “like” for the conversation message, participating in vote, or the like. In addition, the participating subject may be defined as a person or group mentioned in the content of the conversation message, or a person or group invited to the conversation.

The upper and lower message information may include, for example, information on the type of conversation message (e.g., a text, a file, an image, a link, a complex message, etc.) and the content of the conversation message, keywords, tags (e.g., importance, announcement, storage, etc.) of the conversation message, and responses (e.g., the number of likes, emoji reactions, vote, etc.). Furthermore, the content information may include information such as a file, an image, a link, a content, a name of the content included in the conversation message, the number of clicks, and the number of updates.

The thread-type message navigation apparatus 1 extracts the plurality of core elements from information on the thread-type messages stored in the database. Herein, the core element may include a core keyword, a core participant, and a core content of the thread-type messages.

The core keyword may include a keyword registered by a user, a keyword used at high frequency, and a keyword used repeatedly in the upper and lower conversation messages, and may be automatically extracted or provided as a recommended keyword.

The core participant may be selected according to weights applied depending on, for example, the number of created messages, whether the core keyword are included in the created conversation message, and whether the user responds to the conversation message, and may be classified into different types as a creator, a participant, and as a participating subject.

The core content may be selected according to weights assigned to, for example, a higher conversation message or a last conversation message, the conversation message where tags (e.g., importance, announcement, storage, etc.) are set, the conversation message with high responses (e.g., the number of “likes,” reactions, vote, etc.), and the content with a high number of downloads or updates.

The thread-type message navigation apparatus 1 generates thumbnail configuration information using a plurality of extracted core elements as described above. In that case, the thread-type message navigation apparatus 1 may calculate the degree of association with the user using information of the thread-type message stored in the database, and generate thumbnail configuration information by additionally considering the degree of association with the user calculated together with the plurality of extracted core elements. In addition, when generating the thumbnail configuration information, the thread-type message navigation apparatus 1 may further consider the similarity between each thread. In other words, threads with high similarity may be disposed adjacent to each other according to the thumbnail configuration information.

Accordingly, the thumbnail configuration information may be generated by combining at least some of the following: the core keyword, the core participant, the core content, and thread information having high degree of association with the user and high similarity. Furthermore, the thumbnail configuration information may further include statistical information such as the total number of thread-type messages, as well as the number of lower messages, the number of participants, and the period.

The thread-type message navigation apparatus 1 may provide the generated thumbnail configuration information to the user terminal 10, and the user terminal 10 may display a thumbnail view based on the thumbnail configuration information by switching a screen while displaying the thread-type message. In that case, the user terminal 10 may display the thread-type message and the thumbnail view together on one screen.

In addition, the thread-type message navigation apparatus 1 may receive a search request including a keyword input to search for the thumbnail view from the user terminal 10. In that case, the keyword input from the user terminal 10 may include, for example, the keywords registered for each thread, the content of the conversation message, a link name, a file name, a participant, a date, and a period.

The thread-type message navigation apparatus 1 may search for information corresponding to a keyword among information included in the thumbnail configuration information by using the keyword included in the search request of the user terminal 10, and provide the search result to the user terminal 10.

As described above, in the configuration of the system according to one embodiment of the present disclosure, when providing the service of the thread-type messages, the information on the main conversation, main participants, and main content included in a variety of conversation messages may be extracted and provided via an intuitive interface in the form of a thumbnail.

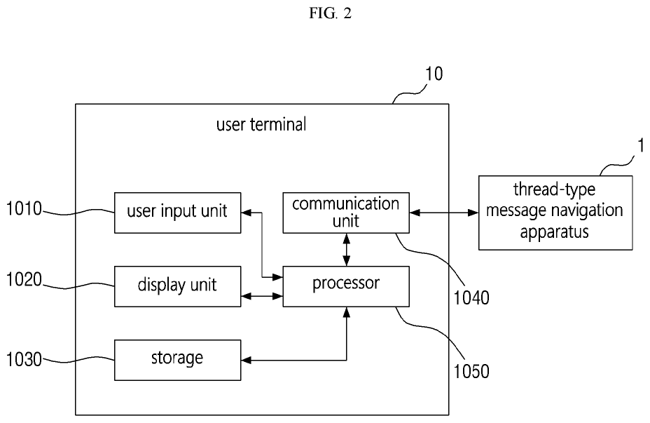

FIG. 2 is a block diagram illustrating a configuration of a user terminal according to one embodiment of the present disclosure. As illustrated, the user terminal 10 according to one embodiment of the present disclosure is connected to the thread-type message navigation apparatus 1 via a network.

The user terminal 10 includes configurations of a user input unit 1010, a display unit 1020, a storage 1030, a communication unit 1040, and a processor 1050. The user terminal 10 may be any one of, for example, a mobile computing device such as a smart phone, a tablet PC, a laptop PC, or a PDA, and a fixed computing device such as a personal desktop PC. The configuration included in the user terminal 10 is not limited to the aforementioned embodiment, and the user terminal 10 may be implemented by including other additional configurations.

The communication unit 1040 communicates with the thread-type message navigation apparatus 1 using a wired or wireless communication scheme. The communication unit 1040 may communicate in a wired communication scheme such as Ethernet, or communicate via a wireless router in a wireless communication scheme such as Wi-Fi or Bluetooth. For example, the communication unit 1040 may be implemented with a printed circuit board (PCB) including a wireless communication module such as Wi-Fi. The communication scheme of the communication unit 1040 is not limited thereto, and the communication unit 1040 may communicate with a server 110 using other communication schemes.

The display unit 1020 displays information. For example, the display unit 1020 may display an image based on an image signal. The display unit 1020 may be implemented with various types such as a plasma display panel (PDP), a liquid crystal display (LCD), an organic light emitting diode (OLED), and a flexible display.

The user input unit 1010 receives a user input. For example, the user input unit 1010 may receive a user input for selecting a part of a user interface displayed on the display unit 1020. The user input unit 1010 may be implemented with a keyboard and a mouse connected to the user terminal 10, or may be implemented as a touch screen provided in the user terminal 10.

The storage 1030 includes a first memory (not shown) and a second memory (not shown), and the first memory is implemented with a nonvolatile memory such as a flash memory so as to preserve data regardless of whether the user terminal 10 is provided with system power.

The first memory stores a plurality of instructions for executing at least one application. The first memory allows each of the plurality of stored instructions to be read, written, edited, deleted and updated.

The second memory is a high-speed buffer memory provided between the first memory and the processor 1050, and is referred to as a cache memory or a local memory. The second memory is faster than the flash memory and may be directly accessed by the processor 1050. As the second memory is an area where data or program instructions frequently accessed by the processor 1050 are stored for further immediate use without repeated search, it may be implemented with, for example, RAM. In one embodiment, the second memory may be integrally provided inside the processor 1050.

The processor 1050 may be implemented with, for example, a central processing unit (CPU).

The processor 1050 displays the thread-type messages where the plurality of conversation messages are grouped on the display unit 1020, and in that case, when there is the user input for the thread-type message, the plurality of core elements are extracted based on the information collected from the thread-type messages, and the thumbnail configuration information on the thread-type messages is generated using the plurality of core elements. Herein, the user input may include, for example, an operation of clicking or touching a button or tab displayed on a screen, an operation of swiping all or some areas of a conversation message, an operation of scrolling a mouse or clicking a shortcut for enlarging or reducing a scale, and a pinch-to-zoom or tap-to-zoom operation.

In one embodiment, the processor 1050 may directly perform an operation of extracting the plurality of core elements and generating the thumbnail configuration information. Alternatively, after the operation is performed by the thread-type message navigation apparatus 1, the processor 1050 may receive the operation result.

The processor 1050 controls the display unit 1020 to display the thumbnail view of the thread-type message by directly generating the thumbnail configuration information or using the thumbnail configuration information provided from the thread-type message navigation apparatus 1. In that case, the thumbnail view may include the thumbnail for all or part of a plurality of conversation messages included in the thread-type messages.

In addition, the thumbnails for each conversation message may be displayed in a list type or a card type, and each of the thumbnails may display a first GUI item including at least one of a text, an image, a table, a file and a link, and a second GUI item including participant information of a corresponding conversation message. When displaying the second GUI item, each participant may be displayed with an individual icon; however, the creator, participant, and participating subject associated with the conversation message may be separated from each other and displayed; furthermore, depending on the degree of participation in the conversation message, the size, color, front-to-back ordering and exposure may be displayed differently. In addition, the number of messages written by the participant may be displayed together near icons corresponding to each of the participants.

In one embodiment, the processor 1050 may periodically perform an operation of extracting the plurality of core elements for the thread-type messages and generating the thumbnail configuration information, and store the extracted core elements and thumbnail configuration information in the storage 1030. In that case, when the user input for the thread-type messages is received, the processor 174 may display the thumbnail view using the thumbnail configuration information stored in the storage 1030.

In one embodiment, the processor 1050 may receive the keyword input to search for the thumbnail view while displaying the thumbnail view for the thread-type message, and may display the search result of the searched thumbnail view using the keyword.

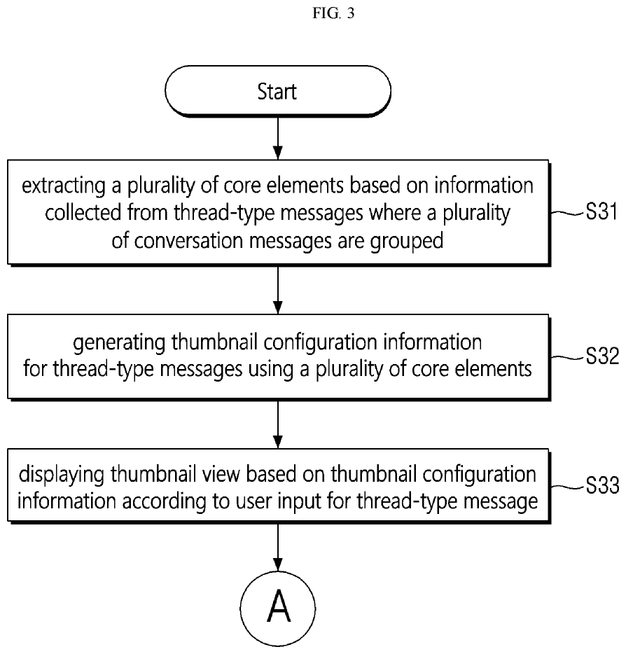

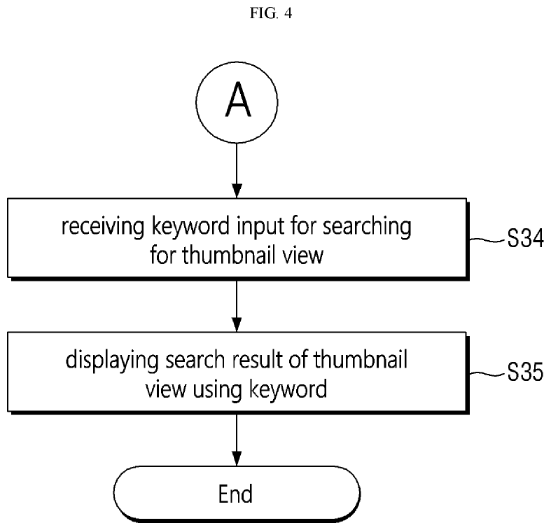

FIGS. 3 and 4 are flowcharts describing a method performed by the user terminal according to another embodiment of the present disclosure. The method according to the present embodiment may be executed by a computing device 100, for example, by the user terminal 10.

The computing device executing the method according to the present embodiment may be a computing device with a program development environment or a computing device with an application program execution environment. Descriptions of the subject of performing some of the operations included in the method according to the present embodiment may be omitted, and in such a case, it is noted that the subject is the computing device.

Referring to FIG. 3, first, in an operation S31, the plurality of core elements are extracted based on information collected from the thread-type messages in which the plurality of conversation messages are grouped. The operation S31 may include an operation of extracting the core keyword, the core participant and the core content of the thread-type messages from the collected information.

The operation S31 may further include an operation of calculating the degree of association with the user based on the information collected from the thread-type messages. In that case, the degree of association with the user may be calculated according to weights assigned based on user message creation, user participation behavior, and user personal settings.

In one embodiment, weights for message creation are assigned according to the ratio of the number of messages created by the user to the total number of conversation messages included in the thread-type message, whether the created message is a higher conversation message or a lower conversation message, and whether the created message includes a core keyword. Furthermore, the degree of association with the user may be calculated therefrom using the weights.

In addition, the user participation behavior is weighted according to a response (“like”, reactions, vote, etc.) left in an individual conversation message and according to whether or not and, if so, how many times the content is viewed/downloaded; in addition, the degree of association with the user may be calculated using the weights therefrom.

In addition, the user personal settings are weighted according to whether or not the user has registered tags (e.g., announcement, storage, etc.) in the individual conversation message, whether and how many keywords of interest previously registered is included, and whether and how many times a previously registered interest party wrote/participated.

Next, in an operation S32, the thumbnail configuration information on the thread-type messages is generated using the plurality of core elements.

The operation S32 may include an operation of generating the thumbnail configuration information by combining the core keyword, the core participant and the core content of thread-type message, and the degree of association with the user. In that case, the thumbnail configuration information may further include statistical information such as the total number of thread-type messages, as well as the number of lower messages, the number of participants, and the period.

In one embodiment, the operations S31 and S32 may not be directly performed by the user terminal 10, but may be performed by the server or the computing device connected to the user terminal 10. In that case, the user terminal 10 may request the navigation request for the thread-type message to the server, and the server may extract the core elements of the thread-type messages and generate the thumbnail configuration information according to the request of the user terminal 10, and then provide the generated thumbnail configuration information to the user terminal 10.

Next, in an operation S33, the thumbnail view based on the thumbnail configuration information is displayed according to the user input for the thread-type messages.

Herein, the operation S33 may include an operation of displaying thumbnails for each conversation message in a list or card type. In addition, the operation S33 may include an operation of displaying thumbnails for all or part of the plurality of conversation messages according to the user input.

In that case, the thumbnails for each conversation message may display a first GUI item including at least one of a text, an image, a table, a file, and a link, and a second GUI item including participant information of the conversation message corresponding to the thumbnail. The second GUI item may display icons corresponding to each participant and the number of messages created by the participant near the icons.

Next, referring to FIG. 4, after performing the operation 33, operations 34 and S35 may be further performed.

In the operation S34, a keyword input to search for the thumbnail view is received, and in the operation S35, a search result of the thumbnail view using the keyword is displayed. In that case, for example, keywords registered for each thread, a content of a conversation message, a link name, a file name, a participant, a date and a period may be input as keywords.

In one embodiment, the method may further include an operation of displaying an original text of the conversation message corresponding to the thumbnail selected according to the user input when receiving the user input for the thumbnail view.

In addition, the method may further include an operation of calculating similarity between the plurality of conversation messages based on information collected from the thread-type messages. In that case, the similarity between the plurality of conversation messages may be calculated based on the ratio of keywords, participants, and content commonly included in the plurality of conversation messages.

For example, the key keywords may be compared for each conversation message, and a conversation message with a high ratio of commonly included core keywords may be weighted. In addition, the conversation message having a high ratio of commonly included participants may be weighted by comparing participants of the conversation message. In addition, the conversation message with a high ratio of common elements may be weighted by comparing the type and name of the content included in the conversation message and a preview content (e.g., a representative text, an image, etc.).

In one embodiment, the method may further include an operation of displaying at least one conversation message having high similarity with the conversation message corresponding to the thumbnail selected according to the user input when receiving the user input for the thumbnail view.

As described above, according to the method for navigating thread-type messages according to one embodiment of the present disclosure, when providing the service of the thread-type messages, core information included in a bundle of various conversation messages can be provided so as to make it easy to understand at a glance, and a convenient interface can be provided to quickly navigate threads with a high degree of association with the user and threads with high similarity. Furthermore, a thread-based search function can be provided without having to search for individual conversation messages one by one to obtain the information desired by the user.

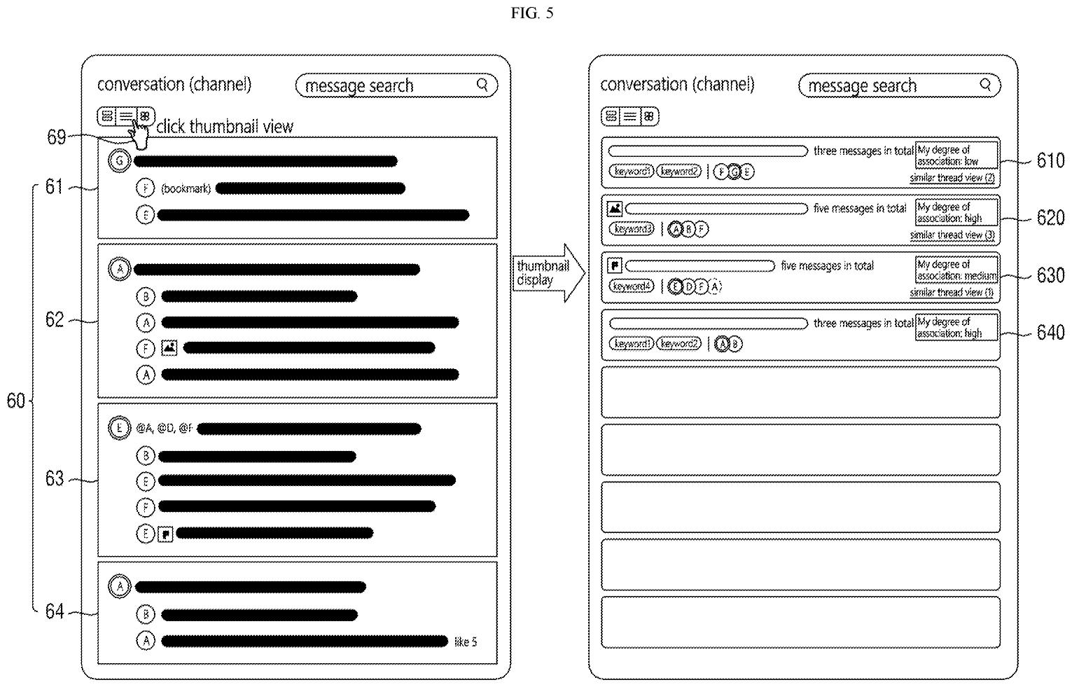

FIG. 5 illustrates an example of providing thumbnails for each thread in the form of a list according to some embodiments of the present disclosure. Referring to FIG. 5, in the case where the user terminal 10 is a PC, when a “thumbnail view” button 69 displayed at the top of the screen is selected by the user while displaying, on the screen, a thread-type message 60 in which the plurality of conversation messages 61, 62, 63 and 64 are grouped, a plurality of thumbnails 610, 620, 630 and 640 may be displayed in a list type instead of the thread-type message 60 by switching a mode of the screen. In that case, each of the thumbnails 610, 620, 630 and 640 may be configured using the core keyword, the core participant, the core content, and the degree of association with the user extracted from each of the conversation messages 61, 62, 63 and 64.

For example, each of the thumbnails 610, 620, 630 and 640 may display a main keyword, and a main conversation content, participants, and a degree of association with me, associated with each of the conversation messages 61, 62, 63, and 64. The degree of association with me may be calculated using, for example, weights assigned according to the message created by the user, the user participation behavior, the user personal settings.

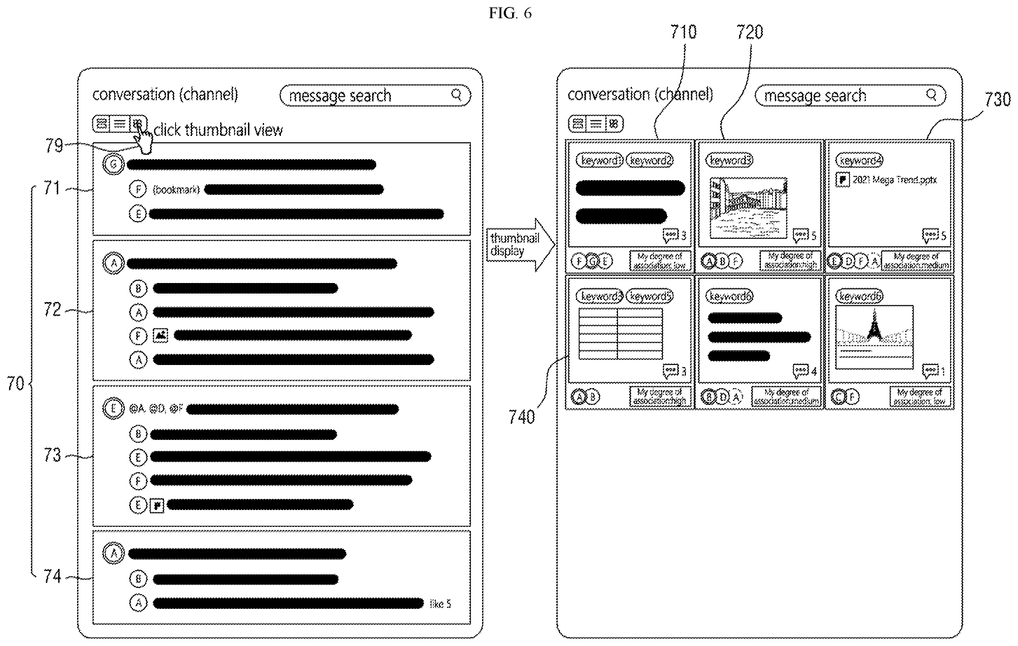

FIG. 6 illustrates an example of providing thumbnails for each thread in the form of a card according to some embodiments of the present disclosure. Referring to FIG. 6, in the case where a “thumbnail view” button 79 displayed at the top of the screen is selected by the user while displaying, on the screen, a thread-type message 70 in which a plurality of conversation messages 71, 72, 73 and 74 are grouped, the user terminal 10 may display a plurality of thumbnails 710, 720, 730 and 740 in a card type instead of the thread-type message 70 by switching the mode of the screen. In that case, each of the thumbnails 710, 720, 730 and 740 may be configured using the core keyword, the core participant, the core content, and the degree of association with the user extracted from each of the conversation messages 71, 72, 73 and 74 and may include, for example, a conversation content, an image, a file, a table and a participant.

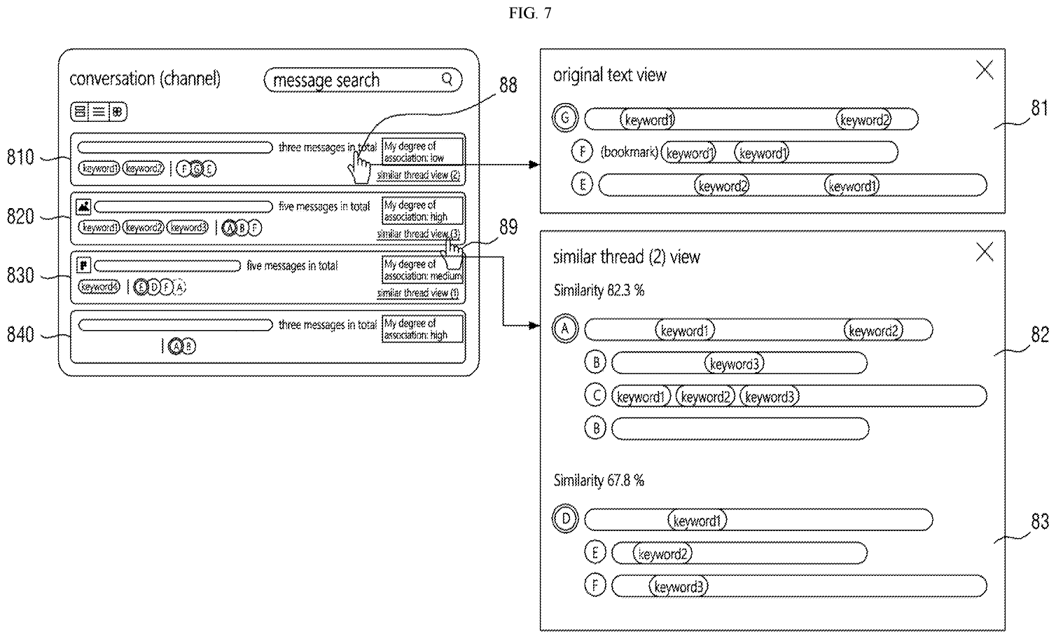

FIG. 7 illustrates an example of displaying an original thread or a similar thread when selecting a thumbnail according to some embodiments of the present disclosure. Referring to FIG. 7, when one thumbnail 810 is selected while displaying a plurality of thumbnails 810, 820, 830 and 840 according to switching to a “thumbnails view” mode for the thread-type message in the example of FIG. 5, the user terminal 10 may display an original text 81 of the conversation message corresponding to the selected thumbnail 810 on the screen.

In addition, when selecting a “similar thread view” link displayed on the thumbnail 810, the user terminal 10 may display conversation messages similar to the conversation message corresponding to the corresponding thumbnail 810 on the screen.

In that case, the similar conversation messages may be extracted as conversation messages with high similarity calculated based on the ratio of keywords, participants, and content commonly included in the conversation message.

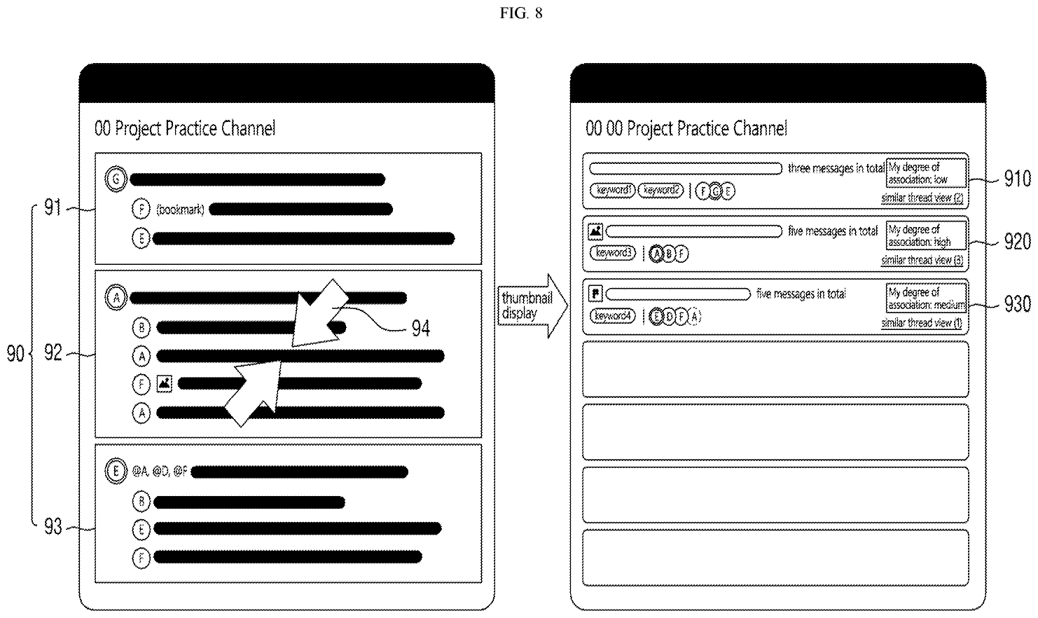

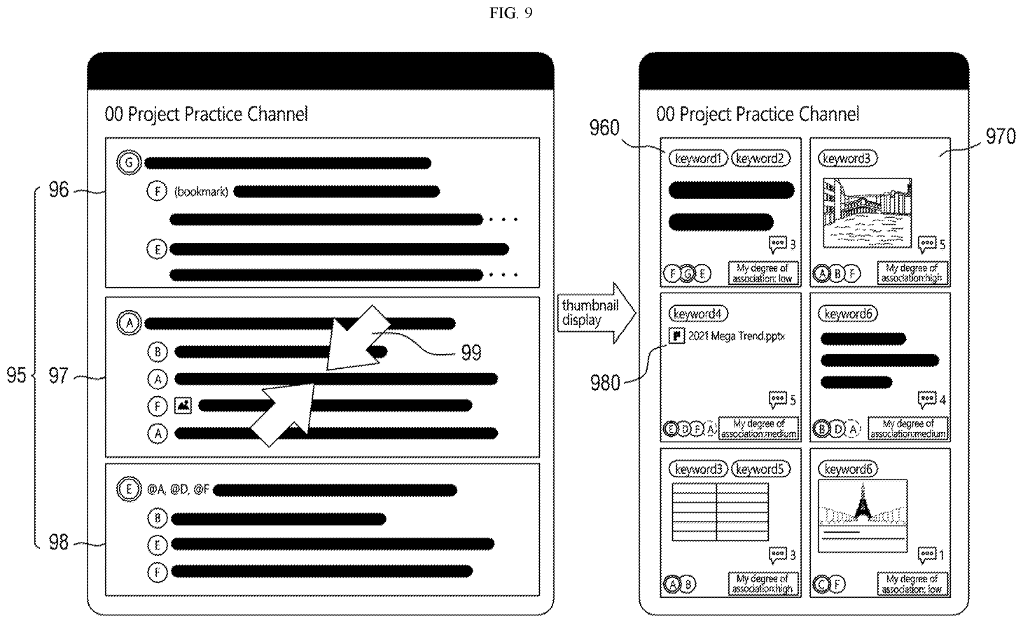

FIGS. 8 and 9 illustrate examples of providing thumbnails for each thread in a mobile device according to some embodiments of the present disclosure. In the example of FIG. 8, in the case where the user terminal 10 is a mobile device, when there is a touch input 94 such as a pinch-to-zoom that reduces the scale of the screen while displaying, on the screen, a thread-type message 90 in which a plurality of conversation messages 91, 92 and 93 are grouped, a plurality of thumbnails 910, 920 and 930 may be displayed in a list type instead of the thread-type message 90 by switching the screen mode. In that case, each of the thumbnails 910, 920 and 930 may be configured using the core keyword, the core participant, the core content, and the degree of association with the user extracted from each of the conversation messages 91, 92, and 93.

In the example of FIG. 9, in the case where the user terminal 10 is the mobile device, when there is a touch input 99 such as a pinch-to-zoom that reduces the scale of the screen while displaying, on the screen, a thread-type message 95 in which a plurality of conversation messages 96, 97 and 98 are grouped, a plurality of thumbnails 960, 970 and 980 may be displayed in a card type instead of the thread-type message 95 by switching the screen mode.

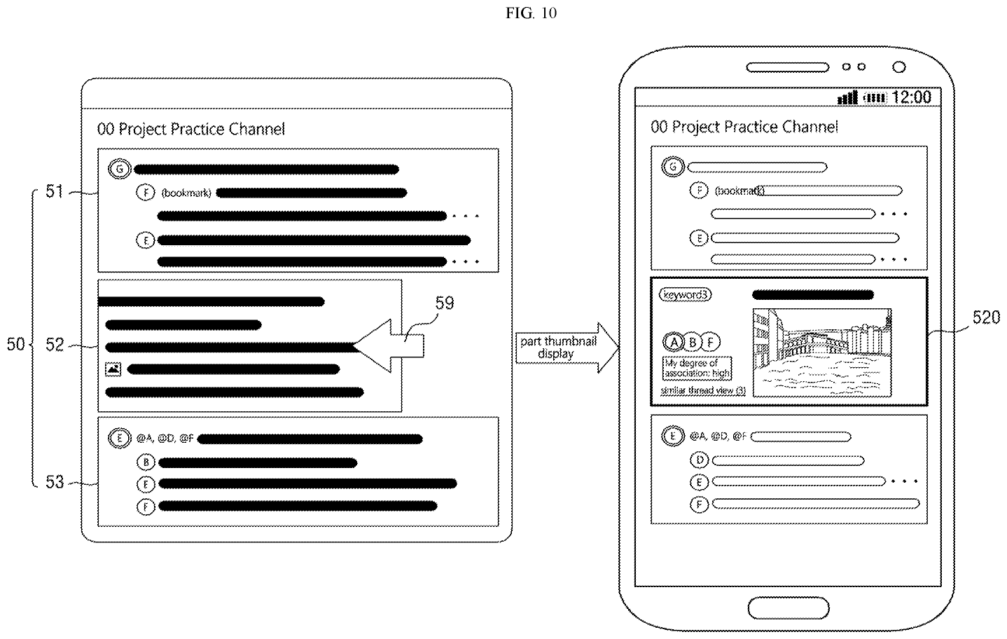

FIG. 10 illustrates an example of displaying a thumbnail for some threads among all threads according to some embodiments of the present disclosure. Referring to FIG. 10, when the user terminal 10 is the mobile device, when there is a touch input 59 that selects one conversation message 52 while displaying, on the screen, a thread-type message 50 in which a plurality of conversation messages 51, 52 and 53 are grouped, a thumbnail 520 corresponding to the conversation message 52 may be displayed on an area where the corresponding conversation message 52 is displayed by not switching the mode for the entire screen, but switching the mode for only a partial area where the corresponding conversation message 52 is displayed.

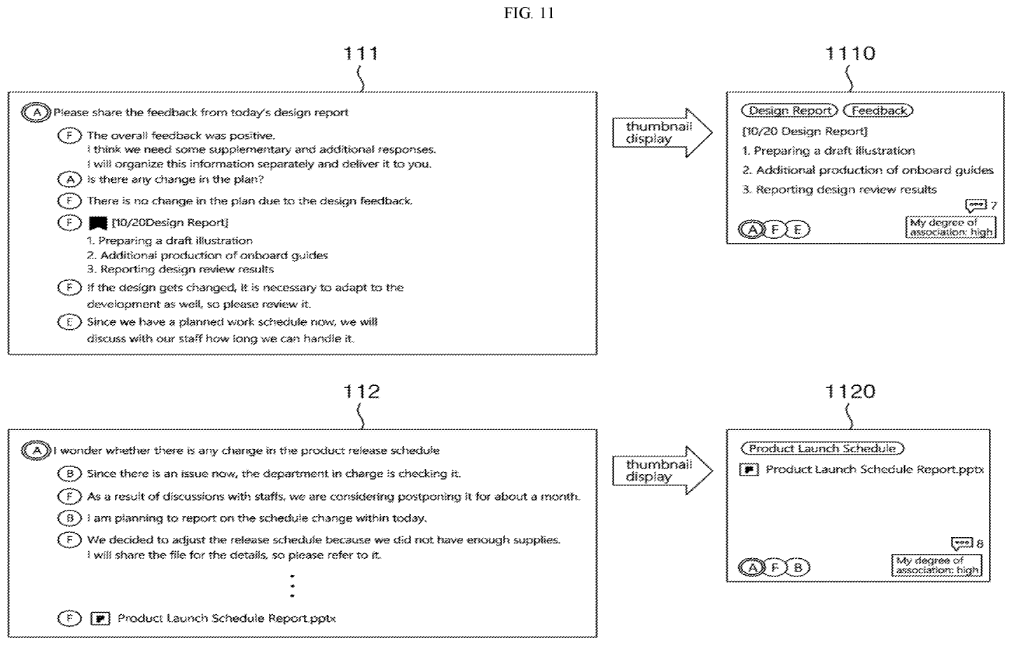

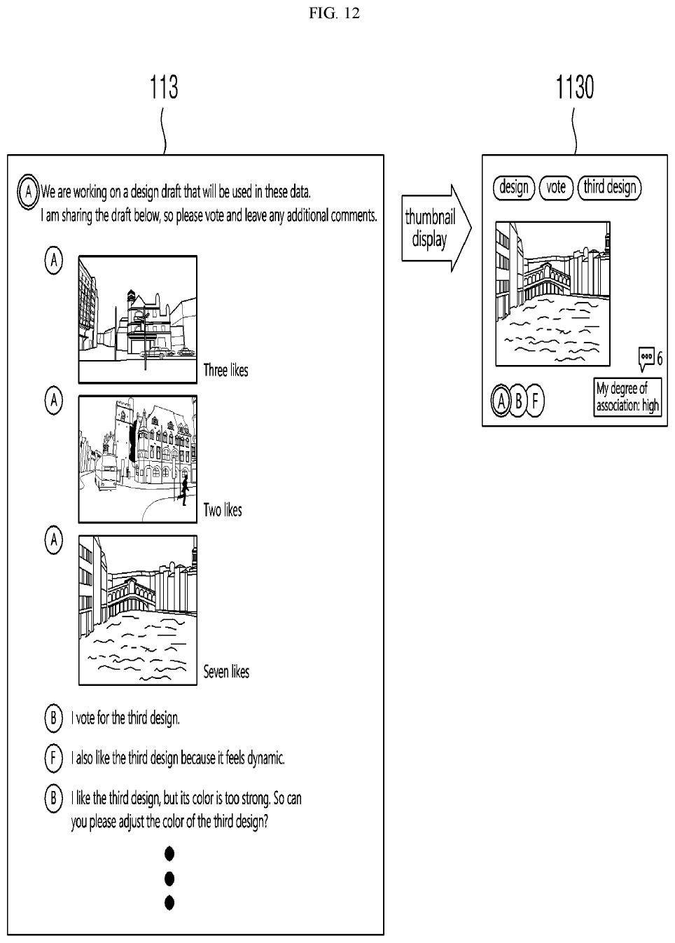

FIGS. 11 and 12 illustrate configuration examples of thumbnails according to some embodiments of the present disclosure. Referring to FIGS. 11 and 12, the user terminal 10 may provide different types of thumbnails according to the type of conversation messages.

For example, a first conversation message 111 is related to design reporting, and a thumbnail 1110 generated corresponding thereto may display “design reporting” and “feedback” derived based on the weight among conversation contents included in the first conversation message 111 as core keywords. The core keywords may be extracted from the first conversation message 111 according to the frequency of inclusion of keywords in the first conversation message 111, whether keywords are words included in the beginning, and whether keywords are in a bookmarked area, or through a keyword extraction algorithm such as a term frequency-inverse document frequency (TF-IDF), and so forth.

In addition, as the thumbnail 1110 is a representative content, it may display a part bookmarked in a text included in the first conversation message 111. When there is no bookmarked part in the first conversation message 111, a result of applying a key sentence selection algorithm for the first conversation message 111 may be displayed as the representative content.

In addition, the thumbnail 1110 may include information on a thread creator or a thread participant who is at least a part of participants. In some embodiments, the thumbnail 1110 may display all creators and all participants of the thread. In some other embodiments, the thumbnail 1110 may display only some of the creators and participants of the thread, which is selected based on a participation level. The participation level may be an index calculated using at least some of the following: the length of the message, the number of messages, and the importance of the message described by each creator and participant. The information on the thread participants may be visualized to confirm the participation levels of each thread participant. For example, as illustrated in FIG. 11, the participants of a first participation level and participants of a second participation level may be visually distinguished and displayed.

In addition, the thumbnail 1110 may additionally include information on the degree of association with the user himself/herself

In addition, a second conversation message 112 is related to a product release schedule, and a thumbnail 1120 generated corresponding thereto may display a core keyword “product release schedule” extracted in the above-described manner among contents included in the second conversation message 112. In addition, the thumbnail 1120 may display an attached content (“product release schedule report.pptx”) derived as a core content from a text and an attached content included in the second conversation message 112. That is, not only the text but also the attached content included in the conversation message may be the core content.

A third conversation message 113 is related to a design proposal vote. Core keywords of the third conversation message 113 are “design”, “vote”, and “third design”. The thumbnail 1130 generated corresponding thereto may display an image that has the highest number of “likes” and is most mentioned among contents included in the third conversation message 113.

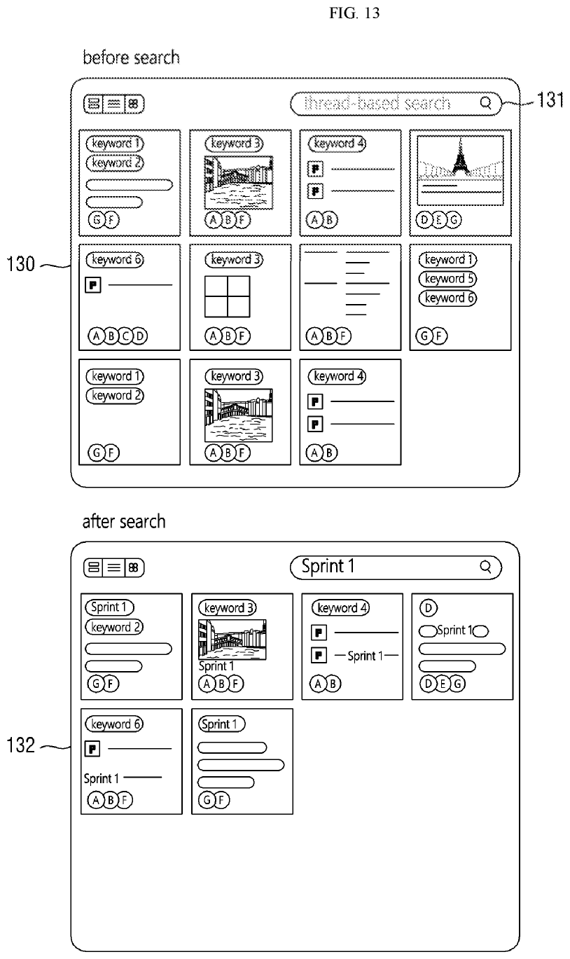

FIG. 13 illustrates an example of providing a search function for a thumbnail according to some embodiments of the present disclosure. Referring to FIG. 13, the user terminal 10 may display a result screen 132 searched using a keyword input to a search window 131 while displaying a thumbnail view 130 for the thread-type message.

In that case, the keyword input to the search window 131 may be, for example, keywords registered for each thread, the content of the conversation message, a link name, a file name, a participant, the date, and the period. In addition, the searched result screen 132 may include only thumbnails associated with input keywords among a plurality of thumbnails included in thumbnail view 130.

According to the aforementioned embodiment, the search function using the thumbnail view may be provided without having to search for each conversation message to obtain information desired by the user.

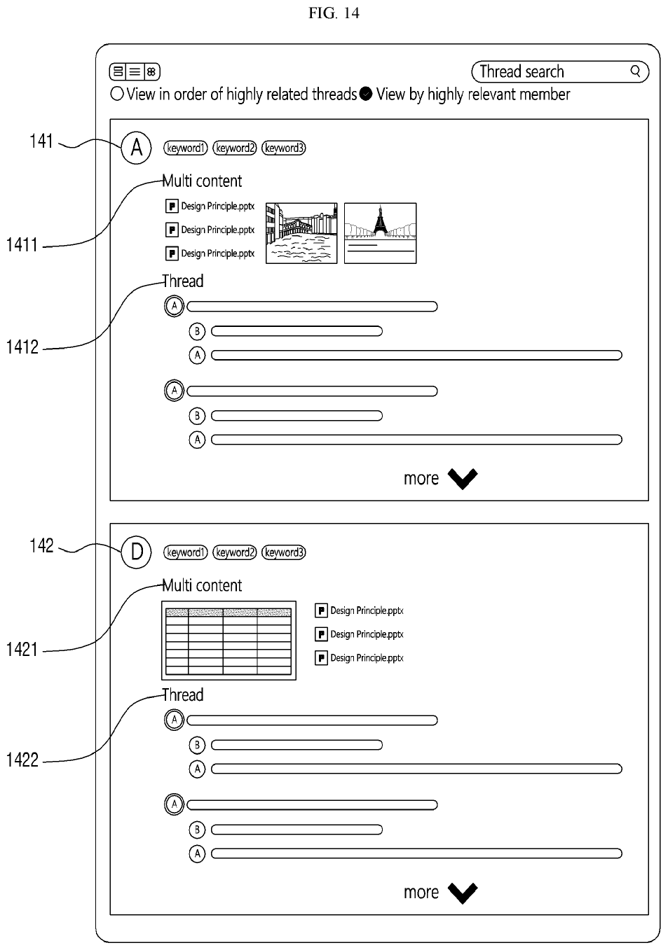

FIG. 14 illustrates an example of displaying the thumbnail based on the degree of association with a user according to some embodiments of the present disclosure. Referring to FIG. 14, the user terminal 10 may provide thumbnails for each member having a high degree of association by using the degree of association with the user. Herein, the degree of association with the user may be calculated according to the weights assigned based on the user message creation, the user participation behavior, and the user personal settings.

In the illustrated example, when providing the thumbnail view of the thread-type message, the user terminal 10 may display a thumbnail for a member A 141 having the highest degree association with the user at the top, and display a content file, an image 1411 and a conversation message 1412 created by the member A in the thumbnail.

In addition, the user terminal 10 may display a thumbnail for a member D 142 with the second highest degree of association with the user in the second order, and display a content file, a table 1421 and a conversation message 1422 created by the member D in the thumbnail.

According to one embodiment of the present disclosure as described above, it is possible to quickly navigate the main content of the message created by members with a high degree of association with the user.

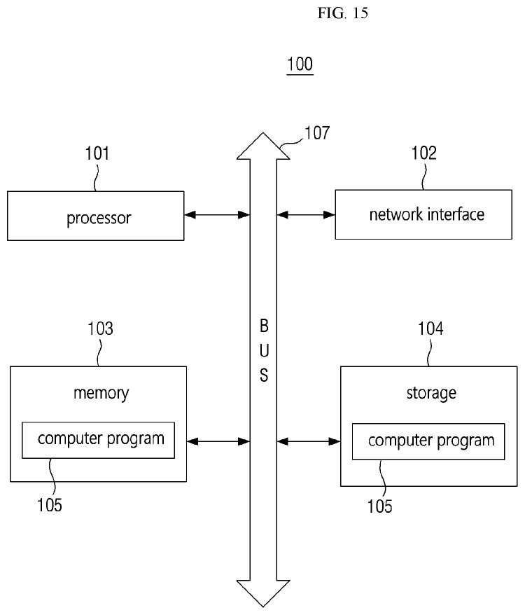

FIG. 15 is a hardware configuration diagram of an exemplary computing device 100.

Referring to FIG. 15, the computing device 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless intemet communication of the computing device 100. The network interface 102 may support various communication methods other than intemet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

In one embodiment, a computer program 105 may include instructions for performing an operation of receiving the navigation request for the thread-type message where the plurality of conversation messages selected from the screen of the user terminal are grouped, an operation of extracting the plurality of core elements based on information collected from the thread-type messages, an operation of generating thumbnail configuration information on the thread-type messages using the plurality of core elements, and an operation of providing the thumbnail configuration information to the user terminal.

In one embodiment, the computer program 105 may include instructions for performing an operation of displaying the thread-type message where the plurality of conversation messages are grouped, an operation of extracting the plurality of core elements based on information collected from the thread-type messages when there is the user input for the thread-type message, an operation of generating the thumbnail configuration information for the thread-type message using the plurality of core elements, and an operation of displaying the thumbnail view based on the thumbnail configuration information.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for navigating thread-type messages performed by a user terminal, the method comprising:
extracting a plurality of core elements based on information collected from the thread-type messages in which a plurality of conversation messages are grouped;
generating thumbnail configuration information on the thread-type messages using the plurality of core elements; and
displaying a thumbnail view based on the thumbnail configuration information , the displaying being based on a user input for the thread-type message.

2. The method for navigating thread-type messages of claim 1, wherein the extracting the plurality of core elements based on the information collected from the thread-type messages in which the plurality of conversation messages are grouped, comprises:
extracting a core keyword, a core participant, and a core content of the thread-type messages from the information collected from the thread-type messages.

3. The method for navigating thread-type messages of claim 1, further comprising calculating a degree of association with a user based on the information collected from the thread-type messages,
wherein the degree of association with the user is calculated according to weights based on user message creation, user participation behavior, and user personal settings.

4. The method for navigating thread-type messages of claim 3, wherein the generating thumbnail configuration information on the thread-type messages using the plurality of core elements comprises:
generating the thumbnail configuration information by combining a core keyword, a core participant and a core content of the of thread-type messages, and the degree of association with the user.

5. The method for navigating thread-type messages of claim 1, wherein the thumbnail configuration information further comprises statistical information comprising at least one of the total number of thread-type messages, the number of sub-messages, the number of participants, or the period.

6. The method for navigating thread-type messages of claim 1, wherein the displaying the thumbnail view based on the thumbnail configuration information comprises:
displaying thumbnails for each conversation message, in a list-type view or card-type view.

7. The method for navigating thread-type messages of claim 1, wherein the displaying the thumbnail view based on the thumbnail configuration information comprises displaying a thumbnail for all or part of the plurality of conversation messages based on the user input.

8. The method for navigating thread-type messages of claim 1, further comprising displaying an original text of the conversation message corresponding to the thumbnail selected based on the user input when receiving the user input for the thumbnail view.

9. The method for navigating thread-type messages of claim 1, further comprising calculating similarity between the plurality of conversation messages based on the information collected from the thread-type messages,
wherein the calculating the similarity between the plurality of conversation messages comprises calculating the similarity based on a ratio of keywords, a ratio of participants and a ratio of content commonly included in the plurality of conversation messages.

10. The method for navigating thread-type messages of claim 9, further comprising displaying at least one conversation message having high similarity with the conversation message corresponding to the thumbnail selected based on the user input, when receiving the user input for the thumbnail view.

11. The method for navigating thread-type messages of claim 1, wherein the thumbnail displays a first graphics user interface (GUI) item comprising at least one of a text, an image, a table, a file or a link, and a second GUI item comprising participant information of the conversation message corresponding to the thumbnail.

12. The method for navigating thread-type messages of claim 1, further comprising:
receiving a keyword for searching for the thumbnail view; and
displaying a search result of the thumbnail view using the keyword.

13. A method for navigating thread-type messages, performed by a computing device, the method comprising:
receiving a navigation request for thread-type messages in which a plurality of conversation messages selected from a screen of a user terminal are grouped;
extracting a plurality of core elements based on information collected from the thread-type messages;
generating thumbnail configuration information on the thread-type messages using the plurality of core elements; and
providing the thumbnail configuration information to the user terminal.

14. The method for navigating thread-type messages of claim 13, wherein the extracting a plurality of core elements based on information collected from the thread-type messages comprises:
extracting core keywords, core participants, and core content of the thread-type messages from the information collected from the thread-type messages.

15. The method for navigating thread-type messages of claim 13, further comprising:
calculating a degree of association with a user based on the information collected from the thread-type messages,
wherein the degree of association with the user is calculated according to weights based on user message creation, user participation behavior, and user personal settings.

16. The method for navigating thread-type messages of claim 15, wherein the generating thumbnail configuration information on the thread-type messages using the plurality of core elements comprises:
generating the thumbnail configuration information by combining a core keyword, a core participant and a core content of the thread-type messages, and the association with the user.

17. A user terminal, comprising:
a communication unit configured to communicate with an external device;
a user input unit configured to receive a user input;
a display unit configured to display information; and
a processor configured to:
display thread-type messages in which a plurality of conversation messages are grouped, on the display unit;
extract a plurality of core elements based on information collected from the thread-type messages when there is a user input for the thread-type messages;
generate thumbnail configuration information on the thread-type messages using the plurality of core elements; and
control the display unit to display a thumbnail view based on the thumbnail configuration information.

18. The user terminal of claim 17, wherein the processor is further configured to calculate a similarity between the plurality of conversation messages based on a ratio of keywords, a ratio of participants and a ratio of content commonly included in the plurality of conversation messages.

19. The user terminal of claim 18, wherein the processor is further configured to control the display unit to display at least one conversation message having high similarity with the conversation message corresponding to the thumbnail selected based on the user input when receiving the user input for the thumbnail view.

20. The user terminal of claim 17, wherein the thumbnail displays a first graphics user interface (GUI) item comprising at least one of a text, an image, a table, a file or a link, and a second GUI item comprising participant information of the conversation message corresponding to the thumbnail.
